(19) United States
(12) Patent Application Publication
(10) Pub. No.: US 2020/0205248 A1
(43) Pub. Date: Jun. 25, 2020

(54) CONTROLLING MICROWAVE HEATING BY MOVING RADIATORS

(71) Applicant: GOJI LIMITED, Hamilton (BM)

(72) Inventors: Ben ZICKEL, Qiryat Bialik (IL); Tatiana DANOV, Beer Sheva (IL); Ronen COHEN, Pardesiya (IL)

(73) Assignee: GOJI LIMITED, Hamilton (BM)

(21) Appl. No.: 16/634,728

(22) PCT Filed: Aug. 14, 2018
(86) PCT No.: PCT/IL2018/050902

§ 371 Date: Jan. 28, 2020

Related U.S. Application Data
(60) Provisional application No. 62/545,608, filed on Aug. 15, 2017.

(51) Int. Cl. H05B 6/72; H05B 6/68; H01Q 21/06; H01Q 1/52; H01Q 5/307; H05B 6/70

(52) U.S. Cl. CPC H05B 6/72; H05B 6/68; H05B 6/705; H01Q 1/521; H01Q 5/307; H01Q 21/061

(57) ABSTRACT

Described are apparatuses and methods for heating an object in a cavity by microwave energy. The apparatus includes, in some embodiments, multiple antennas; a microwave source configured to feed the cavity with microwave energy via the multiple antennas; and multiple radiators. Each of the radiators is configured to controllably move so as to couple the source to a respective one of the multiple antennas or decouple the source from the respective one of the multiple antennas.

### RELATED APPLICATIONS

This application claims the benefit of priority under 35 USC § 119(e) of U.S. Provisional Patent Application No. 62/545,608 filed Aug. 15, 2017, the contents of which are incorporated herein by reference in their entirety.

### BACKGROUND

The present invention, in some embodiments thereof, relates to microwave ovens and methods of their control, and in particular to microwave ovens comprising a plurality of antennas.

A microwave oven heats and cooks food by application of electromagnetic energy in the microwave frequency range to a cavity having the food therein.

Microwave ovens tend to heat food quickly while using less energy compared to a standard oven, but are difficult to control to achieve a desired heating result by a user. For example, users may stop the heating process multiple times to check the status of the food. Moreover, microwave ovens tend to heat foods unevenly, which may make it difficult to cook foods in a microwave oven. For example, frozen foods may cook at certain parts while other parts remain frozen.

### SUMMARY

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

An aspect of some embodiments of the invention includes an apparatus for heating an object in a cavity by microwave energy. The apparatus may include: multiple antennas;

a microwave source configured to feed the cavity with microwave energy via the multiple antennas; and

multiple radiators, each configured to controllably move so as to couple the source to a respective one of the multiple antennas or decouple the source from the respective one of the multiple antennas.

In some embodiments, each of the radiators is in a respective waveguide open to the cavity. In some such embodiments, each of the radiators is electrically isolated from the waveguide.

In some embodiments, the apparatus further includes an excitation chamber, excitable by microwaves from the microwave source, and wherein each radiator of the plurality of radiators is configured to couple the excitation chamber to the cavity through one of the plurality of antennas.

In some embodiments, the excitation chamber is structured to guide microwaves from the microwave source preferentially towards the radiators.

Alternatively or additionally, the apparatus may further include at least one motor configured to move each of the plurality of radiators in respect to the cavity independently of the movements of the other radiators. In some such embodiments, each of the at least one motor is electrically isolated from the radiator.

In some embodiments, the antennas are arranged in a two dimensional array.

In some embodiments, the apparatus may further include a user interface configured to allow a user to provide instructions to heat the object differently by different ones of the plurality of antennas.

In some embodiments, the apparatus may further include a processor configured to:

select at least one of the antennas; and

control at least one of the radiators to move so that each selected antenna is coupled to the microwave source, and each antenna not selected is not coupled to the microwave source.

Alternatively or additionally, the apparatus may further include a processor configured to:

select at least one of the antennas based on instructions provided via the user interface; and

control at least one of the radiators to move so that each selected antenna is coupled to the microwave source, and each antenna not selected is not coupled to the microwave source.

In some embodiments, the apparatus may further include a processor configured to:

receive instructions to heat the object differently by different ones of the plurality of antennas; and

control movement of the plurality of radiators based on the instructions.

An aspect of some embodiments of the invention may include a method of heating an object by an apparatus comprising multiple radiators and a microwave source configured to feed the cavity with microwave energy via multiple antennas, each configured to be coupled to the cavity by a respective radiator of the multiple radiators. The method may include:
selecting at least one antenna; and
controlling at least one radiator to move in respect to the cavity so that each selected antenna is coupled to the microwave source, and each antenna not selected is not coupled to the microwave source.

In some embodiments, each of the radiators is in a respective waveguide open to the cavity, and the method comprises controlling the radiator to move in the waveguide towards an opening between the cavity and the waveguide or away of the opening.

In some embodiments, the apparatus comprises an excitation chamber, excitable by microwaves from the microwave source, and the method includes controlling the radiators to move so that the selected antennas couple to the excitation chamber, and the antennas not selected are not coupled to the excitation chamber.

In some embodiments, controlling a radiator to move comprises controlling a motor to move the radiator.

In some embodiments, the method may further include:

receiving instructions to what extent to heat the object by each one of the plurality of antennas; and

controlling movement of the plurality of radiators based on the instructions.

In some such embodiments, receiving instruction comprises receiving from a user interface configured to allow a user to provide instructions to heat the object differently by different ones of the plurality of antennas.

In some embodiments, the method may further include:

monitoring the amount of energy coupled to the cavity by each of the antennas; and

comparing amounts of energy coupled to amounts of energy determined to be coupled. Optionally, controlling movement of the plurality of radiators comprises controlling based on the comparison.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a diagrammatic presentation of a microwave oven heating an object according to some embodiments of the invention;

FIG. 1B is a diagrammatic presentation of a microwave oven according to some embodiments of the invention;

FIG. 2 is a diagrammatic presentation of a microwave oven heating an object according to some embodiments of the invention;

FIG. 3A and FIG. 3B are diagrammatic illustrations of how a tuning member may affect the position of a field pattern in respect to various radiators according to some embodiments of the invention;

FIG. 4A, FIG. 4B, and FIG. 4C are diagrammatic presentations of three different arrangements of radiators in accordance with three embodiments of the present invention; and

FIG. 5 and FIG. 6 are two flowcharts of methods of heating an object in a cavity of a microwave heating apparatus in accordance with some embodiments of the invention.

### DETAILS DESCRIPTION OF EMBODIMENTS OF THE INVENTION

### Overview

Microwave heating is many times uneven in a manner that is very hard to control. An aspect of some embodiments of the invention includes improving heating uniformity by feeding microwaves from multiple different antennas. In some such embodiments, each antenna heats preferentially a different part of the object to be heated, and the overall heating uniformity may be improved in comparison to using only a single antenna. In some embodiments, using multiple antennas may also serve to heat unevenly in a controlled manner, for example, heating one portion of the object to be heated more than another portion. This may be facilitated by using multiple antennas, for example, in embodiments where the antennas are very close to the object, e.g., when the object lies on a tray that rests on the antennas or otherwise held close to the antennas. The antennas heat their immediate surrounding more than remote portions of the object, so controlling one antenna to heat while controlling another not to heat may lead to heating one portion of the object (which is close to the heating antenna) more than another portion (which is far from any heating antenna).

The term microwave, as used herein, refers to electromagnetic radiation in the frequency range of between 30 MHz to 30 GHz, and in most cases between 400 MHz and 6 GHz. The microwaves used for heating according to some embodiments of the invention fall only within one or more ISM frequency bands, for example, between 433.05 and 434.79 MHz, between 902 and 928 MHz, between 2400 and 2500 MHz, and/or between 5725 and 5875 MHz. ISM frequency bands are frequency bands that the regulatory authorities allow using for industrial, scientific, and medical uses under relatively permissive restrictions regarding the radiation intensity allowed to leak from the apparatus. Working only within these frequency bands may allow simplifying the means used for leakage prevention.

The object to be heated by an apparatus according to embodiments of the present invention may include, for example, a food item. In some embodiments, the object may include a plurality of frozen food items arranged on a tray at predetermined locations, so that the oven may have information on which food item resides at which position in the cavity.

Heating by different antennas (and optionally, at different times by different antennas) may be achieved by switching antennas on or off. In some embodiments, switching the antennas on or off is carried out using a movable radiator. The radiator radiates microwave signals it receives (directly or indirectly) from a microwave source. The signals radiated by the radiator may or may not couple to an antenna configured to feed the cavity depending on the position of the radiator in respect to the antenna. For example, in some embodiments the cavity has an opening, and an edge of the opening functions as an antenna feeding the cavity with signals supplied to the antenna by the radiator. In such an example, when the radiator is close to the opening, or even protruding into the cavity, signals radiated by the radiator may be supplied to the antenna. If, on the other hand, the radiator is far from the antenna, the signals radiated by the radiator may not couple to the antenna, and thus also not reach into the cavity. When signals from the microwave source reach the antenna, the antenna is said to be coupled to the source, and so is the cavity.

As used herein, the term “radiator” refers to a component along an RF propagation path, the path going from an RF power source (e.g., from the amplifier) to the cavity, and characterized in that without it—no significant amount of RF power enters the cavity, and no significant amount of RF power leaks outside the apparatus. In this context, “significant” is larger than a threshold, for example, larger than 10% of the power that would reach the cavity in presence of the radiator. For example, a waveguide connecting an RF power source to a cooking cavity is not considered a radiator since the removal of the waveguide will cause a significant amount of RF waves leakage to the environment. Also, a coupler coupling signal portions to power meters is not a radiator, since without it significant amount of RF power may reach the cavity, and there will be no particular leak to the environment. In some embodiments, a radiator is provided in a leakage preventing structure that together with the radiator may form an antenna. A radiator may be, but not necessarily is, the closest component to the cavity along the propagation path, where closeness is measured along wave propagation. Such a radiator may be referred to herein as an edge radiator.

Coupling between a radiator and the cavity exists only if most of the power outputted by the source reaches the cavity. If most of the power returns to the radiators, none of the radiators may be considered coupled to the cavity. If there is coupling between the radiators and the cavity, a given radiator is considered coupled to the cavity only if none of the other radiators feed the cavity with significantly more forward power than the given radiator. In this context “significantly more” may mean twice, 60% more, 40% more, or any intermediate or larger extent. A given position of a radiator may be considered a coupled position if the radiator is coupled to the cavity when it is in said position.

A microwave “source” may include any components that are suitable for generating electromagnetic energy in the microwave range. In some embodiments, the source may include a magnetron. Alternatively or additionally, the source may include a solid state oscillator (e.g., voltage controlled oscillator) or synthesizer (e.g., direct digital synthesizer) and/or a solid state amplifier (e.g., a field effect transistor).

As used herein, if a machine (e.g., an antenna) is described as being “configured to” perform a particular task (e.g., configured to feed the cavity), then, the machine includes components, parts, or aspects (e.g., software, connections, position, orientation, etc.) that enable the machine to perform the particular task. In some embodiments, the machine may perform this task during operation.

As used herein, a cavity may be any space bounded by electrical conductors so that at least one frequency supplied by the source resonates in the cavity. In some embodiments, when empty, the cavity supports only one mode. In some embodiments, the empty cavity supports a plurality of degenerate modes, that is, all the supported modes are excitable at the same frequency and belong to the same mode family. The mode family may be one of: Transverse Electric (TE), Transverse Magnetic (TM), Transverse Electromagnetic (TEM), and hybrid.

Accordingly, some embodiments of the invention include a microwave oven with multiple antennas, each having a respective radiator. When an antenna is to be coupled to the source a radiator is moved to a position where the antenna and the source are coupled. When an antenna is to be decoupled from the source, the radiator is moved to a position where the antenna and the source are decoupled from each other.

In some embodiments, each radiator is fed by its own source. However, in some embodiments there is a single source feeding all the antennas, or at least multiple antennas. In some such embodiments, there is a waveguide that guides signals from the source to multiple radiators. For example, the source may feed a single waveguide, also referred herein as an excitation chamber. The excitation chamber may have a different opening for each antenna, and a radiator associated with an antenna moves to couple the opening in the excitation chamber to the antenna or to decouple between them.

In some embodiments, the distance between the antenna and the object may be large in comparison to a wavelength (in vacuum) of the microwave radiation used for the heating. For example, the distance may be 1 or more wavelengths. In some embodiments, the antennas are arranged to be very close to the object to be heated, for example, the distance between them may be ¼ of a wavelength or less. Such short distance may cause the object to be heated much more in regions close to a radiating antenna than in regions away from the radiating antenna. This may allow controlled uneven heating. For example, if a dish containing fresh vegetables and pasta is to be prepared in the oven, the antenna close to the vegetables may be decoupled from the source, and the antenna close to the pasta may be coupled to the source, so that the pasta heats substantially, while the vegetables don't heat or nearly don't heat. In some embodiments, the radiators are moved to couple the source to antennas near regions to be heated and decoupled the source from antennas near regions not to be heated. In some such embodiments, the frequency of the source and the structure of the antennas and cavity may be designed to allow mainly or only heating by evanescent fields that decay exponentially on their way from the antenna to the object. In some embodiments, the apparatus may be designed for specific objects, or to objects of specific characteristics, that allow propagation of the evanescent fields in the object. The specific characteristics of the objects may include, for example, a dielectric constant of the object at the microwave frequency used for the heating (e.g., relative permittivity of between 20 and 60). Another example of a specific characteristic may be the maximal depth of the object (perpendicular to the antenna). For example, an apparatus may be designed to process mainly objects having thickness of 0.5 cm to 5 cm.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

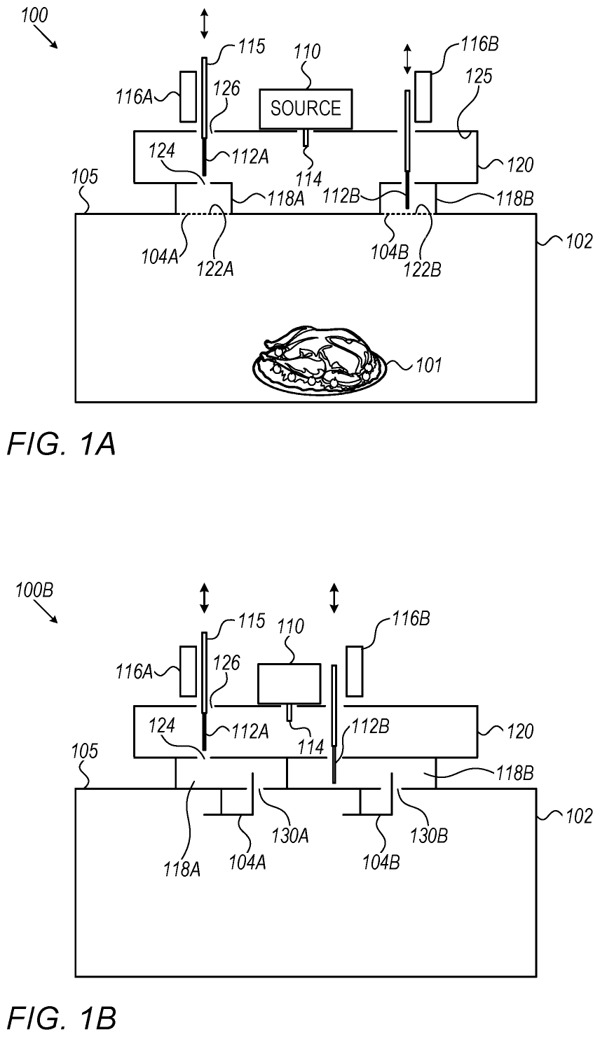

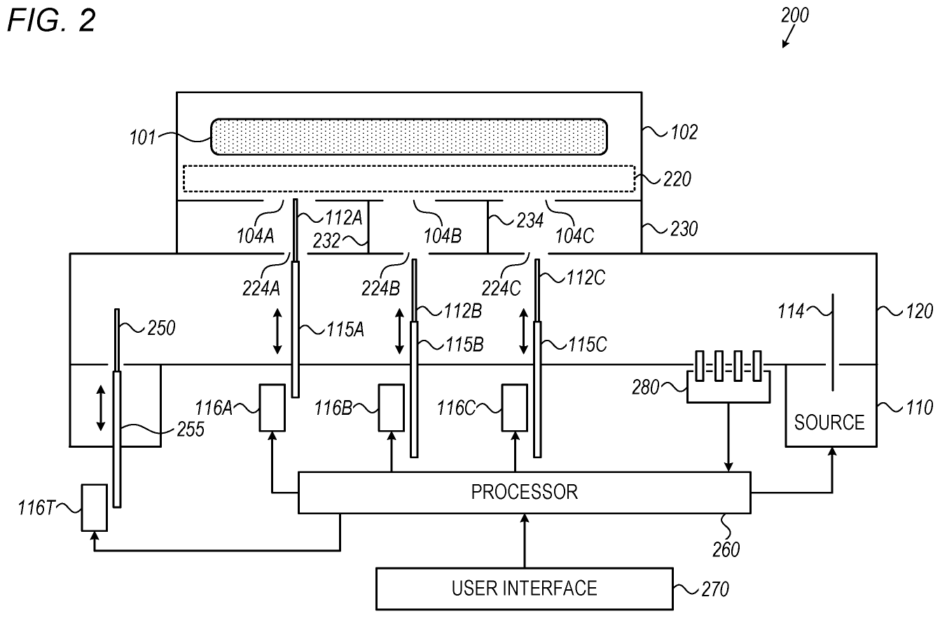

FIG. 1A is a diagrammatic presentation of a microwave oven 100 heating object 101 according to some embodiments of the invention. Oven 100 may be a microwave oven for cooking food, or any other apparatus configured to heat an object in a cavity by microwave energy. Microwave oven 100 includes a cavity 102, in which object 101 is to be heated. Object 101 may lie on the cavity floor as shown in the drawing, or be carried on a tray (not shown), which, in some embodiments, may be a rotating tray. Cavity 102 may include slot antennas 104a and 104b, for example, at cavity ceiling 105. Antennas 104 may irradiate into cavity 102 radiation they receive from source 110. In some embodiments, source 110 may include a magnetron, and in some embodiments may include a solid state microwave source. In some embodiments, the frequency of microwave signals the source supplies may be controlled. The antennas may include, for example, slot antennas (as illustrated), monopole antennas inverted F antennas (IFAs), etc.

Microwave signals from source 110 may excite electromagnetic waves in excitation chamber 120, e.g., via an excitation pin 114. Preferably, excitation chamber 120 is coupled to cavity 102 only via radiators 112A, 112B and corresponding waveguides 118A and 118B. For example, if radiator 112A ends out of waveguide 118A (as depicted in the drawing), antenna 104A may be decoupled from excitation chamber 120, and thus also from source 110. If radiator 112B ends inside waveguide 118B, and close enough to slot antenna 104B (as depicted in the drawing), antenna 104B may be coupled to cavity 102, and thus feed the cavity with microwave radiation. Also, each radiator 112 is sufficiently long so that a portion thereof is penetrating into excitation chamber 120, even when it is advanced to touch cap 122 (see radiator 112B). The radiator and isolating member are designed so that when the radiator is used for coupling between two structures (e.g., between excitation chamber 120 and waveguide 118A) it has at least a non-isolated portion in each of the structures to be coupled. In addition, the isolating portion is designed to always have a portion inside excitation chamber 120 and one portion outside the excitation chamber, to connect to motor 116A or 116B. The motors may be collectively referred to as motor 116. As used herein, the term motor may relate to any electricity driven device that supplies motive power to any part of the apparatus, for example, to a radiator. The motor may include (or take the form of) a solenoid, a linear motor, linear actuator, etc. In some embodiments, the motor may allow positioning the radiator in one of two predetermined positions, for example, a coupled position and a decoupled position. In some embodiments, the motor may allow moving the radiator to more than two positions to allow more flexibility in the degree of coupling obtained, and/or to allow tuning the coupling. In some embodiments, movement between more than two positions may be step wise, e.g., with a step motor. In some embodiments, the movement between the more than two positions may be continuous, e.g., linear motor or actuator. To control the coupling of the cavity to the source via a particular antenna, the respective radiator may be moved. For example, to couple antenna 104A to source 110 radiator 112A may be moved towards antenna 104A (in the drawing this means downwards), and to decouple antenna 104B from source 110, radiator 112B may be moved away from antenna 104B (in the drawing this means upwards). In some embodiments, each radiator has a respective motor 116 configured to move the respective radiator towards the respective antenna and away therefrom.

In some embodiments, motors 116A and 116B may be electrically isolated from radiators 112. For example, the motors may be physically connected to the radiator only via an isolating member 115. Isolating member 115 may include a cover covering at least a portion of radiator 112. In some embodiments, the isolating members may have such a length that non-isolated portions of radiator 112 do not penetrate out of excitation chamber 120 even when the radiator is at its most retracted position, e.g., similar to radiator 112A in the drawing. In some embodiments it is ensured that electrically conducting bodies in excitation chamber 120 penetrate from excitation chamber 120 only towards cavity 102. The motors may be controlled by a processor (not shown in FIG. 1).

In some embodiments, each of the radiators is in a respective waveguide open to the cavity. For example, waveguides 118A and 118B serve to guide waves from excitation chamber 120 to slot antennas 104A and 104B, respectively. In some embodiments, waveguides 118A and 118B are separated from the interior of cavity 102 by caps 122A and 122B. This may allow protecting the radiators from heat and humidity in the cavity. In some embodiments, caps 122A and 122B may be microwave transparent in the sense that they do not interfere in the coupling of the radiators to the antennas, do not absorb microwaves supplied by the source, and/or do not reflect microwaves supplied by the source.

In some embodiments, each radiator 112 is electrically isolated from metallic structures in its vicinity, e.g., cavity 102, excitation chamber 120, and/or waveguide 118. For example, waveguide 118 or ceiling 105 may include openings 124, through which radiator 112 goes into cavity 102 and/or waveguide 118. Openings 124 may be somewhat wider than radiator 112, and the radiator may be arranged never to touch edges of the openings. In some embodiments, openings 124 may include an insulating ring (not shown) ensuring that the radiator is electrically isolated from the cavity. Similarly, excitation chamber 120 may include openings 126 to allow insertion of radiators 112 into the excitation chamber. In some embodiments, each radiator 112 goes through a respective opening 126 into excitation chamber 120 and continues through opening 124 into waveguide 118 (and/or cavity 102). Radiators 112 may be electrically isolated also from edges of openings 126.

FIG. 1B is a diagrammatic presentation of a microwave oven 100B for heating an object (not shown) according to some embodiments of the invention. Oven 100B is similar to oven 100 illustrated in FIG. 1A, but uses inverted F antennas instead of the slot antennas of oven 100. Microwave oven 100B includes a cavity 102, in which the object is to be heated. Cavity 102 may include inverted F antennas 104A and 104B, for example, at cavity ceiling 105. Antennas 104A and 104B may irradiate into cavity 102 radiation they receive from source 110. Microwave signals from source 110 may excite electromagnetic waves in excitation chamber 120, e.g., via an excitation pin 114. Preferably, excitation chamber 120 is coupled to cavity 102 only via radiators 112A, 112B (and respective waveguides 118A and 118B). For example, if radiator 112A ends outside waveguide 118A (as depicted in the drawing), antenna 104A may be decoupled from excitation chamber 120, and thus also from source 110. If radiator 112B ends inside waveguide 118B (as depicted in the drawing), antenna 104B may be coupled to cavity 102, and thus feed the cavity with microwave radiation. Openings 130A and 130B are provided to allow penetration of antennas 104A and 104B to waveguides 118A and 118B, respectively. Openings 124, 126, and 130 are all of a diameter much smaller than any wavelength emitted from source 110 in order to heat the object.

In some embodiments, each of the radiators may be coupled to the respective antenna through a respective waveguide coupler. For example, waveguide couplers 118A and 118B serve to guide waves from excitation chamber 120 to inverted F antennas 104A and 104B, respectively. In some embodiments, each radiator 112 is electrically isolated from metallic structures in its vicinity, e.g., excitation chamber 120, and/or waveguide coupler 118. For example, waveguide couplers 118A and 118B may include openings 124, through which radiator 112 goes into the waveguides. Openings 124 may be somewhat wider than radiator 112, and the radiator may be arranged never to touch edges of the openings. In some embodiments, openings 124 may include an insulating ring (not shown) ensuring that the radiator is electrically isolated from the cavity. Similarly, excitation chamber 120 may include openings 126 to allow insertion of radiators 112 into the excitation chamber. In some embodiments, each radiator 112 goes through a respective opening 126 into excitation chamber 120 and continues through opening 124 into waveguide 118. Radiators 112 may be electrically isolated also from edges of openings 126.

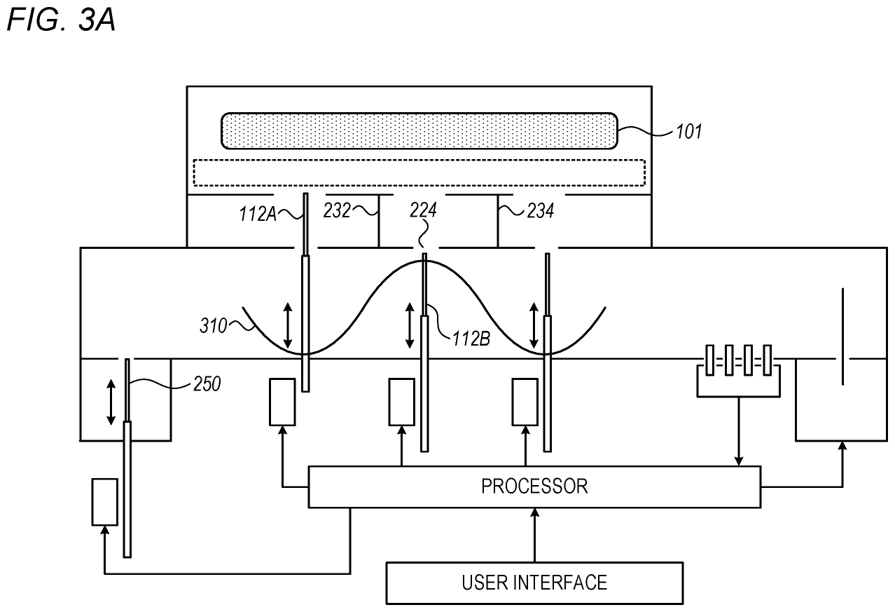

FIG. 2 is a diagrammatic presentation of a microwave oven 200 heating object 101 according to some embodiments of the invention. Oven 200 may be a microwave oven for cooking food, or any other apparatus configured to heat an object in a cavity by microwave energy. Parts marked with the same numerals as in FIG. 2 are generally structured and function similarly to their counterparts in FIG. 1. However, in oven 200 the object to be heated is very close to radiators 112A, 112B and 112C, so it may be heated by near field effects. Typically, near field are prominent if the distance between object 101 and the edge of the radiator near it is at most ¼ wavelength of the heating radiation, when propagating in the medium separating the radiator from the object. In oven 200, object 101 lies on top of a support 220. In some embodiments, support 220 may be microwave transparent in the sense that it does not absorb microwaves supplied by the source. For example, support 220 may be made of glass, having a dielectric constant of 6 at a frequency of 2.45 GHz. At a frequency of 2.45 GHz, the wavelength in vacuum is 12.25 cm, and in the glass: 12.15 cm/√6=5 cm. Near field effects may therefore be prominent if the glass thickness is 5 cm/4=1.25 cm or less. Near field heating may result in preferential heating near the radiator, and thus selective heating may be obtained by selecting proper radiators, each of which heats preferentially in its vicinity. In some embodiments, support 220 does absorb and reflect microwaves supplied by the source, but the absorption and reflection coefficient are smaller than some predetermined values, e.g., absorption coefficient smaller than 0.2_{1/cm}, or smaller than 0.1_{1/cm} or an intermediate or smaller value. Nevertheless, in some embodiments, support 220 may influence the spread of the microwaves towards the object: if the support is very thin (e.g., between about 1 mm—and about 3 mm), the object will be heated intensely in the vicinity of the antennas, and much less so away of them. If the support is thicker, (e.g., between about 30 mm and about 100 mm), or if it is held at some distance above the antennas, the field may spread over larger area, and provide less intense and less focused heating. In some embodiments, the location of the support in respect to the antennas may be tuned. For example, cavity 102 may include several grooves (not shown), for fitting the support edges into them. In some embodiments, there may be a first support for protecting the radiators from heat and humidity in the oven; and a second support, for tuning the distance between the lower side of the object to be heated and the antennas.

In some embodiments, the object to be heated lies close enough to the antennas (illustrated in the figure as slot antennas 104), to allow the object to be heated mainly in the vicinity of the antennas. Therefore, selective heating may be obtained by heating differently (e.g., for different time and/or power level) by different antennas. A portion of the object that lies directly above one antenna may be heated very efficiently by the antenna under it, and negligibly by any one of the other antennas. A portion of the object that lies between two antennas may be heated moderately by each one of them. In some embodiments, for example, in embodiments where the object is nearly in direct contact with the antennas, the antennas may feed the microwave energy from excitation chamber 120 to object 101, while cavity 102 may be only nominally fed, other than in portions occupied by the object.

In some embodiments, support 220 may replace caps 122 (of apparatus 100) in protecting the radiators from heat and humidity in the cavity. In some embodiments, support 220 is static. In some embodiments, support 220 may be rotatable. If the support rotates, object 101 may be heated differently at different rings centered at the center of rotation of the support. Each ring may have a radius similar to the distance of a respective radiator 112 from the center of rotation.

Microwave signals from source 110 may excite electromagnetic waves in excitation chamber 120, e.g., via an excitation pin 114. In some embodiments, excitation chamber 120 is coupled to cavity 102 only via radiators 112A, 112B, and 112C. For example, when a radiator is positioned with its end far from the corresponding slot antenna (like radiators 104B and 104C are far from slot antennas 104B and 104C in the drawing), the antennas are decoupled from excitation chamber 120, and thus also from source 110. When radiator 112A is positioned with its end close to a slot antenna, (like radiator 112A is close to slot antenna 104A in the drawing), the antenna may be coupled to cavity 102, and thus feed the cavity with microwave radiation.

In some embodiments, more than one radiator may be coupled to the cavity at overlapping time periods. In objects that are not symmetrical, this may be less desired than coupling each radiator at a time, since simultaneous coupling provides a lesser degree of control, and in some embodiments even a lesser degree of determination, of how much power or energy is fed through each of the simultaneously coupled radiators. However, if the object is symmetrical, and especially if the radiators are far from the object (e.g., at a distance larger than a wavelength from the object) coupling two antennas at overlapping times may cause interference inside the object, and may allow for better control of heating uniformity.

To control the coupling of the cavity to the source via a particular antenna, the respective radiator may be moved, e.g., by motors 116A, 116B, or 116C (collectively referred to herein as motor 116), and the motion of the radiators may be controlled, e.g., by processor 260. For example, in some embodiments, the processor may control the motors to move the radiators so that each radiator is moved into a coupling position for a predetermined period of time, and then moves to a decoupling position for a predetermined period of time. In this context, coupling position is a position at which the radiator couples the antenna corresponding thereto to the source; and decoupling position is a position at which the radiator does not couple the antenna corresponding thereto to the source, so the source and the antenna are decoupled. Similarly, each radiator may be assigned by the processor a coupling period (that is, a period during which the radiator is in a coupling position) and decoupling period (that is, a period during which the radiator is in a coupling position). In some embodiments, each radiator is in a decoupling position as long as one of the other radiators is in a coupling position. In some embodiments, each radiator is assigned the same coupling period. The coupling period may be substantially longer than the moving period, which is the period it takes to move a radiator from a coupling position to a decoupling position or in the other direction. For example, if the duration of a moving period is 2 seconds, the coupling period may have duration of 10 seconds, 20 seconds, 30 seconds, 60 seconds, or any intermediate duration. In some embodiments, the decoupling period is the total coupling periods of all the other radiators. For example, if there are 6 radiators, the moving period of each is 3 seconds, and the coupling period of each is 20 seconds, the decoupling of each is 100 seconds.

As used herein, the term “processor” may include an electric circuit that performs a logic operation on input or inputs. For example, such a processor may include one or more integrated circuits, microchips, microcontrollers, microprocessors, all or part of a central processing unit (CPU), graphics processing unit (GPU), digital signal processors (DSP), field-programmable gate array (FPGA) or other circuit suitable for executing instructions or performing logic operations.

The instructions executed by the processor may, for example, be pre-loaded into the processor or may be stored in a separate memory unit such as a RAM, a ROM, a hard disk, an optical disk, a magnetic medium, a flash memory, other permanent, fixed, or volatile memory, or any other mechanism capable of storing instructions for the processor. The processor(s) may be customized for a particular use, or can be configured for general-purpose use and can perform different functions by executing different software.

If more than one processor is employed, all may be of similar construction, or they may be of differing constructions electrically connected or disconnected from each other. They may be separate circuits or integrated in a single circuit. When more than one processor is used, they may be configured to operate independently or collaboratively. They may be coupled electrically, magnetically, optically, acoustically, mechanically or by other means permitting them to interact.

In some embodiments, processor 260 is configured to receive instructions from user interface 270. User interface 270 may include an input system that allows a user inputting data for use by processor 260. For example, the user interface may include a keypad, knobs, buttons, touch screen, a reader of machine readable elements, etc. Examples of machine readable elements include barcode QR code, and RFID. In some embodiments, user interface 270 may include a screen configured to present to the user an identifier of the product to be heated. The identifier may include, for example, an image, icon, and/or name. In some embodiments, the identifier may be in response to data inputted by the user through the user interface. For example, the user may read a barcode from a package of a food item to be heated, and the screen may present an image of a product of the kind coded with the barcode. For example, the barcode may be of a TV dinner of a certain kind, and the image may be of a typical TV dinner of that kind. In some embodiments, the identifier may be based on an image taken by a camera integrated into the apparatus, for example, a camera embedded in a wall of cavity 102. The camera may produce an image of the object inside the cavity (or, in embodiments where the camera is outside the cavity, an image of the object facing the camera). User interface 270 may also allow the user to mark various portions of the identifier, and provide heating instructions for each portion. For example, the user may mark one portion of the identifier with instructions to cook, and another portion with instructions to defrost only.

In some embodiments, processor 260 is configured to determine, e.g., based on instructions received from a user via user interface 270, an amount of energy to be absorbed by the object near each of the antennas. In some embodiments, this amount is the same for all the antennas, so the heating is designed to be substantially uniform. In some embodiments, processor 260 may determine that portions of the object adjacent to different ones of the antennas are to absorb different amounts of energy, so as to achieve non-uniform heating or to adjust to different heating capacities of different portions of the object. In some embodiments, the processor may monitor the amount of energy absorbed by the object when heated by each of the antennas. In some embodiments, such measurements are carried out using a four-port coupler 280 and a power meter (not shown) measuring the power at each of the four ports separately. The four ports may be positioned in respect to each other so they measure the forward power (F), going from the source to the cavity; the backward power (B), going from the cavity to the source; a sum of the forward power and the backward power (F+B) and the complex conjugate of the sum (F+iB). Some other arrangement may be similarly helpful, for example, measuring F, B, F+B, and (F−iB); F, B, F−B and (F−iB); F, B, F−B and (F+iB); etc. Each one of these arrangements allows calculating actual forward (F_{actual}) and actual backward (B_{actual}) powers even if the measurements are inaccurate, e.g., due to low directivity of coupler 280. In some embodiments, the amount of power absorbed by the object P_{absorbed}) may be evaluated by processor 260, for example, by subtracting the backward power from the forward power (F_{actual}−B_{actual}). The amount of energy absorbed may be then evaluate by processor 260, e.g., by integrating the absorbed power over time. An amount of energy absorbed may be associated with each one of the antennas (or, similarly, with each one of the radiators corresponding to the antennas, or with each one of the object portions in the vicinity of the corresponding antenna). This may be done by bookkeeping separately energy absorbed during coupling period of each radiator.

In some embodiments, processor 260 may be configured to compare amounts of energy absorbed associated with each one of the antennas, and control heating parameters accordingly. The heating parameters may include, for example, movement of the radiators and/or power levels supplied by the source when each radiator is in coupling position. In some embodiments, processor 260 may determine, e.g., based on instructions received through user interface 270, that uniform heating is required in the sense that each radiator has to supply to the object the same amount of energy, e.g., 100 kJ. The processor may begin the heating by heating with full power for 10 second periods with each radiator in coupling position at a time, e.g., 10 seconds with radiator 112A at coupling position and the other radiators in decoupling positions; then 10 seconds with radiator 112B at coupling position, etc., At the same time, the processor may monitor the amount of energy absorbed through each of the antennas. If it appears that the object absorbed from one of the antennas more energy than from the other ones, the processor may shorten the coupling period of this antenna, and/or lengthen the coupling periods of the other antennas. Similar considerations may be applied when there is a determination that the amounts of energy absorbed should differ among different antennas. Generally, the amounts of energy evaluated to be absorbed in practice are compared to the amounts of energy planned to be absorbed, and coupling periods are adjusted to compensate for differences revealed between amounts measured to be absorbed and amounts planned to be absorbed. In some embodiments, when an amount of energy planned to be absorbed out of energy supplied through a certain antenna equals the amount of energy absorbed in practice out of the energy supplied through the said antenna, heating with the said antenna is stopped.

In some embodiments, motors 116 may be electrically isolated from radiators 112. For example, the motors may be physically connected to the radiator only via an isolating member 115. Each of isolating members 115A, 115B, and 115C (generally referred to herein as isolating member 115) may include a cover covering at least a portion of radiator 112. In some embodiments, the isolating members may have such a length that non-isolated portions of radiator 112 do not penetrate out of excitation chamber 120 even when the radiator is at its most retracted position, e.g., similar to radiator 112B in the drawing. In some embodiments it is ensured that electrically conducting bodies in excitation chamber 120 penetrate from excitation chamber 120 only towards cavity 102, and never in the opposite direction.

In some embodiments, each of the radiators is in a respective waveguide open to the cavity, as depicted in FIG. 1. In the embodiment described in FIG. 2, the radiators share a common waveguide 230. Waveguide 230 is coupled to excitation chamber 120 only via openings 224A, 224B and 224C, collectively referred to herein as opening(s) 224. Waveguide 230 may be divided into sections by metallic walls, e.g., metallic walls 232 and 234, which operate to separate between the antennas. In the drawing, wall 232 separates between antennas 104A and 104B, and wall 234 separates between antenna 104B and 104C. In embodiments where the cavity is fed with microwave radiation of the same frequency through all the antennas, the sections of waveguide 230 (which may be separate waveguides) are all of substantially the same dimensions.

Similarly, each radiator 112 may be electrically isolated from motors 116, and more generally, from the environment surrounding apparatus 200. For example, excitation chamber 120 may include openings (not explicitly marked in FIG. 2), through which radiator 112 goes out of the bottom side of excitation chamber 120. The radiators may be arranged never to touch excitation chamber 120. In some embodiments, the openings may include an insulating ring (not shown) ensuring that the radiator is electrically isolated from the excitation chamber. In some embodiments, each radiator 112 goes through a respective opening into excitation chamber 120 and continues through opening 224 into waveguide 230.

In some embodiments, apparatus 200 may further include a tuning member 250, configured to change the electromagnetic field distribution inside excitation chamber 120. Tuning member may have an isolating portion 255 that isolates between the (electrically conductive) tuning member and a motor 116T configure to move the tuning member. In some embodiments, tuning member 250 is isolated also from the body of excitation chamber 120 or any other electrically conductive part of apparatus 200. In some embodiments, excitation chamber 120 is structured to guide microwaves from the microwave source preferentially towards the radiators. For example, Excitation chamber 120 may include static tuning members (not shown), that may enhance the matching between the excitation chamber and openings 124. The static tuning chambers may include floating tuning members, which are isolated from any of the metallic parts of apparatus 200, grounded tuning members, which are electrically connected to excitation chamber 120 or other metallic part of apparatus 200, or both floating and grounded static tuning members.

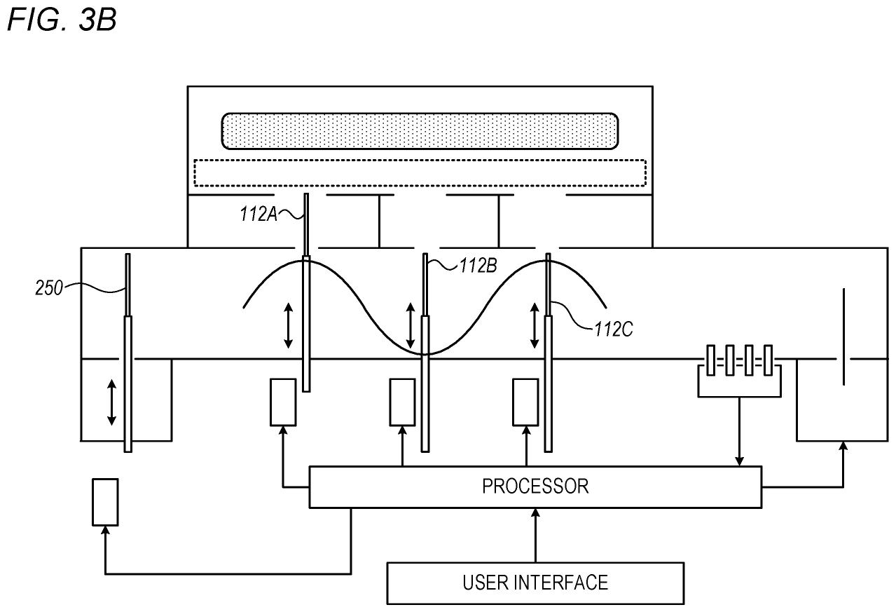

In some cases, a radiator might fail coupling between the source and the object regardless the position of the radiator in respect to the antenna. This may happen, for example, if the radiator happens to lie on a node in the electromagnetic field generated in excitation chamber 120, as symbolically illustrated in FIG. 3A. A node, as used herein, is a region wherein the field intensity has a local or global minimum. In the figure, the electromagnetic field in the vicinity of the radiators is represented by a sinusoidal line 310, describing the field intensity. As can be seen, radiator 112A lies in a region where the field intensity is minimal. In such a case, radiator 112A can hardly couple any amount of energy from source 110 to object 101. Radiator 112B is at a field maximum, and therefore could have coupled the object to the source effectively, but its position in respect of openings 224 does not allow significant coupling to take place. Moving the tuning member, for example, to the position illustrated in FIG. 3B may cause the field to change, so that radiators 112A and 112C are at field maximums, and radiator 112 is in a coupling position, so it couples the object to the source efficiently. In some embodiments, even if moving tuning member 250 does not change the coupling so dramatically as in FIGS. 3A and 3B, the coupling does depend on the position of the tuning member. In some embodiments, the coupling may be measured (e.g., by measuring a dissipation ratio (D) between absorbed power (P_{absorbed}) and forward power (F). Under some reasonable assumptions, D=(F_{actual}−B_{actual})/F_{actual}. In some embodiments, the tuning member may be moved to find, e.g., by trial and error, the position of tuning member 250, at which the dissipation ratio is maximal.

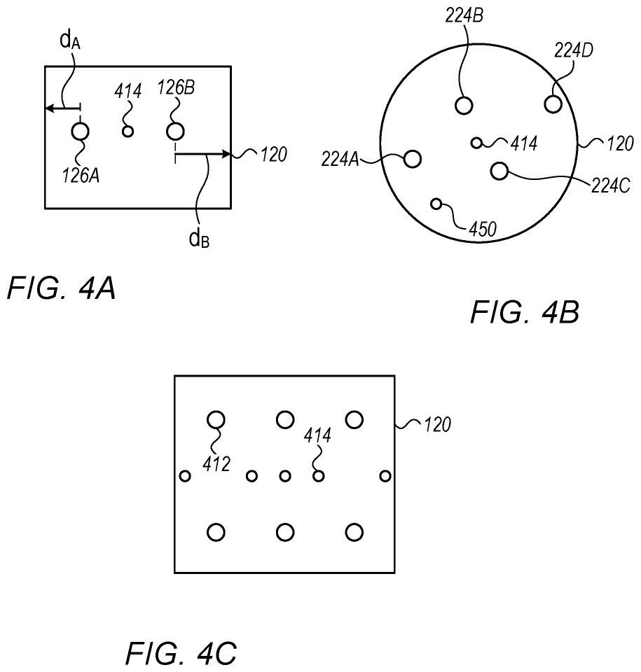

FIG. 4A-FIG. 4C describe three different arrangements of radiators in accordance with three embodiments of the invention. FIG. 4A is a diagrammatic presentation of ceiling 125 of excitation chamber 120 shown in FIG. 1. The figure shows openings 126A and 126B, and an opening 414, through which excitation pin 114 can protrude into excitation chamber 120. The openings are not necessarily symmetrical in respect to the edges of excitation chamber 120. For example, in the drawing, distance d_{A} between opening 126A and the left wall of excitation chamber 120 is shorter than distance d_{B} between opening 126B and the right wall of the excitation chamber. In some embodiments, the radiator positioning is chosen so that each radiator excites in the cavity a different mode, e.g., when the cavity is empty.

FIG. 4B is a diagrammatic presentation of ceiling 125 of excitation chamber 120 in another embodiment. FIG. 4B relates to an apparatus having a cylindrical shape. Cylindrically shaped (or otherwise degenerate) excitation chambers usually allow for exciting a larger number of field patterns at a given number of frequencies, in comparison to the number of field patterns excitable at the same frequencies with non-degenerate cavities. This is so especially in ovens with the radiators lying far away (e.g. at a distance of about 1 wavelength or more) from the object to be heated. The figure shows opening 414 for excitation pin 114; opening 450 for tuning member 250, and openings 224A-224D for four radiators. Here also, the openings are not necessarily arranged in symmetrical order. For example, each radiator opening may be at a different distance to the circular edge of excitation chamber 120. In some embodiments, the opening for the magnetron pin is larger than the openings for the radiators, but this is not necessarily the case.

FIG. 4C is a diagrammatic presentation of a wall (e.g., ceiling, bottom part, or a side wall) of an excitation chamber in an apparatus according to embodiments of the present invention. The figure shows opening 414 for an excitation pin (e.g., 114) and 10 openings 412 for radiators arranged in a two-dimensional array. Two dimensional arrays of radiators may allow obtaining greater flexibility in controlling which areas are heated and which are not. As a rule of thumb, it may be advantageous to have a number of radiators per surface area across the object to be heated, especially if near field effects are to be utilized. Thus, if the oven itself is long and narrow (e.g., having an aspect ratio of 5:1), a one dimensional array (e.g., line) of radiators may be sufficient. If the aspect ratio is smaller (e.g., between 5:2 and 1:1), a two dimensional array of radiators may be more effective than a one dimensional array.

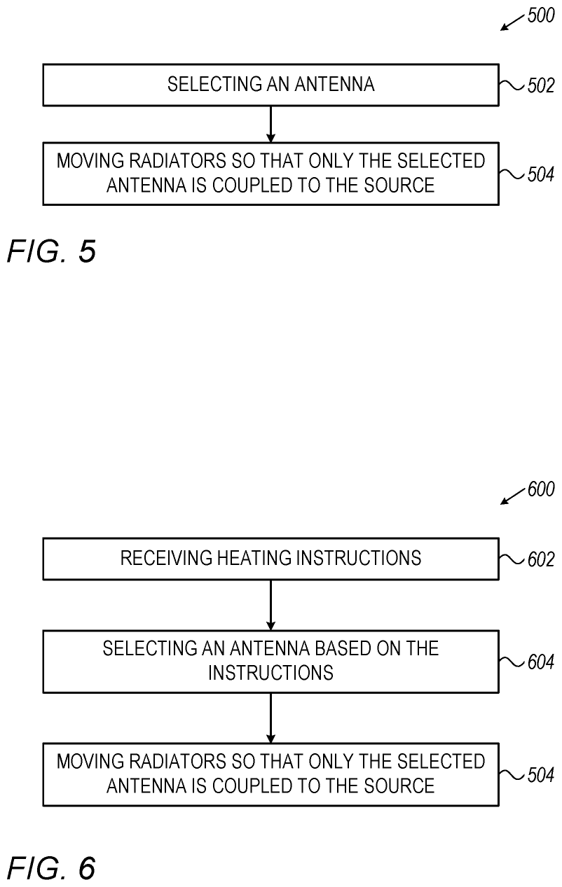

FIG. 5 is a flowchart 500 of a method of heating an object in a cavity of a microwave heating apparatus in accordance with some embodiments of the invention. The method may be carried out using an apparatus comprising multiple radiators and a microwave source as described above, for example, in the context of FIG. 1 or 2. In more detail, the apparatus may include a source configured to feed the cavity with microwave energy via multiple antennas, and each antenna may be configured to be coupled to the cavity by a respective radiator of the multiple radiators. Flowchart 500 includes box 502, in which at least one antenna is selected; and box 504, in which at least one radiator is controlled to move in respect to the cavity so that each selected antenna is coupled to the microwave source, and each antenna not selected is not coupled to the microwave source. In some embodiments, steps 502 and 504 are repeated, where in each repetition a different antenna is selected. For example, the method may include heating by all the antennas, but with one antenna at a time. In such methods, in each repetition a different antenna may be selected, and steps 502 and 504 may be repeated at least once for each antenna. In some embodiments, the antennas are selected one after the other in a plurality of cycles, wherein in each cycle one or more of the antennas is selected. The instructions which antenna to select at each cycle may be given in advance, and in some embodiments, may be decided by the processor based on feedback received from the power meters (e.g., power meters 114), or from other sensors, such as temperature sensors, humidity sensors, etc. For example, the processor may not select antennas associated with too large reflections, so that heating efficiency is enhanced. In some embodiments, the selection of an antenna may be based on instructions received, e.g., via a user interface. For example, if the instructions are not to heat at all a portion of the object that lies in the vicinity of one of the antennas, this may affect the antenna selection of box 502, e.g., as to cause that antenna never to be selected for heating the object under these instructions.

In some embodiments, the selection may be based on temperature feedback from the object. For example, the temperature of the object in the vicinity of each antenna may be measured, and the decision whether or not to select an antenna may be affected by a difference between a temperature reading received from the vicinity of the antenna and a target temperature for object portions in the vicinity of the antenna. The target temperature may be received, for example, through a user interface.

In some embodiments, the selection may be based on feedback concerning amounts of energy absorbed in various portions of the object. For example, the difference between forward power supplied through a given antenna and backward power received through the same antenna at the same time may indicate the power absorbed by a portion of the object in the vicinity of the given antenna. This indicated power may be integrated over time to tell how much energy is absorbed by that object portion. By summing separately the energy absorbed by object portions lying in the vicinity of each of the antennas, the amount of energy absorbed by each portion of the object may be estimated. A decision whether or not to select an antenna may be affected by a difference between the amount of energy estimated to be absorbed in an object portion, and an amount of energy instructed to be absorbed in that object portion. The instructions may be received, for example, through a user interface.

In some embodiments, the radiators may be selected based on reflections measured with each of them coupled to the cavity on its own. For example, in some embodiments, only radiators, the coupling of which to the cavity is associated with reflections smaller than a threshold are selected. The threshold may be, for example, 0.1, 0.25, 0.5, or intermediate number.

In some embodiments, like, for example, in the embodiment shown in FIG. 1, each of the radiators is in a respective waveguide, and each of the respective waveguides has an opening open to the cavity. In some such embodiments, the control related to in box 504 may include controlling the radiator to move in the waveguide towards the opening between the cavity and the waveguide or away of the opening.

In some embodiments, the apparatus comprises an excitation chamber, excitable by microwaves emerging from the microwave source. In some such embodiments, coupling an antenna to the source is by coupling the antenna to the excitation chamber, and the controlling of box 504 may include controlling the radiators to move so that the selected antennas couple to the excitation chamber, and the antennas not selected are not coupled to the excitation chamber.

The controlling of box 504 may include controlling a distinct motor to move each of the radiators to be moved, or any other mechanism that allows for controlling the movement of several radiators together, for example, a crank shaft or a camshaft.

FIG. 6 is a flowchart 600 of a method of heating an object in a cavity of a microwave heating apparatus in accordance with some embodiments of the invention. Flowchart 600 includes a box 602, at which heating instructions are received, e.g., via a user interface. The heating instructions may include instructions to obtain some final heating results. For example, the heating instructions may include instructions to heat the object uniformly. In some embodiments, the instructions may be more detailed, and include instructions to let each portion of the object absorb the same amount of energy or heat to the same temperature. In cases where the different portions of the object have the same heat capacity the two last options (i.e., instructing to heat by same energy amounts and instructions to heat to the same temperature) are equivalent. Heating instructions that relate to different portions of the object may be given in terms of different portions, that each lies at the vicinity of a different antenna.

In some embodiments, the heating instruction may include instructions to heat different portions of the object to different temperatures, and/or to let different portions of the object absorb different amount of energy. In some embodiments, the instructions may include instructions to go through two or more stages, so that each step is characterized by a certain RF power to be absorbed in the object as a whole, in a certain part of the object, or in different parts of the object. In some embodiments, each step may be characterized by a temperature to be reached by the object as a whole, by a certain part of the object, or by different portions of the object. For example, the instructions may be first to defrost a food portion, and then to cook the frozen food portion. The defrosting stage may be characterized by a first set of instructions, and the cooking stage may be characterized by another set of instructions. Stopping criteria for each step do not necessarily depend on amounts of energy absorbed or on temperature reached. Rather, any measureable condition may be used as a stopping criterion. For example, a stage may be accomplished when an S parameter of one of the antennas reaches a certain value, or crossed a given threshold. In some embodiments, stopping criteria for a stage may include a target value for the S matrix of the system. Similarly, changes in S parameters or matrices (e.g., changes over time) may be used as stopping criteria for a stage.

Flowchart 600 also includes a box 502, in which an antenna is selected for transferring microwave energy into the object. The selection of an antenna may be based on instructions received at 602, for example, as described above in relation to flowchart 500.

Flowchart 600 also includes a box 604, at which movement of the plurality or radiators is controlled based on the instructions received at 602.

In the foregoing Description of Exemplary Embodiments, various features are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment of the invention.

Moreover, it will be apparent to those skilled in the art from consideration of the specification and practice of the present disclosure that various modifications and variations can be made to the disclosed systems and methods without departing from the scope of the invention, as claimed. For example, one or more steps of a method and/or one or more components of an apparatus or a device may be omitted, changed, or substituted without departing from the scope of the invention. Thus, it is intended that the specification and examples be considered as exemplary only, with a true scope of the present disclosure being indicated by the following claims and their equivalents.

1. An apparatus for heating an object in a cavity by microwave energy, the apparatus comprising: multiple antennas;
a microwave source configured to feed the cavity with microwave energy via the multiple antennas; and
multiple radiators, each isolated from the cavity and configured to controllably move so as to couple the source to a respective one of the multiple antennas or decouple the source from the respective one of the multiple antennas.

2-3. (canceled)

4. The apparatus of claim 1, further comprising an excitation chamber, excitable by microwaves from the microwave source, and wherein each radiator of the plurality of radiators is configured to couple the excitation chamber to the cavity through one of the plurality of antennas.

5. The apparatus of claim 1, further comprising at least one motor configured to move each of the plurality of radiators in respect to the cavity independently of the movements of the other radiators.

6. The apparatus of claim 5, wherein each of the at least one motor is electrically isolated from the radiator.

7. The apparatus of claim 1, wherein the antennas are arranged in a two dimensional array.

8. The apparatus of claim 1, further comprising a user interface configured to allow a user to provide instructions to heat the object differently by different ones of the plurality of antennas.

9. The apparatus of claim 1, further comprising a processor configured to:
select at least one of the antennas: and
control at least one of the radiators to move so that each selected antenna is coupled to the microwave source, and each antenna not selected is not coupled to the microwave source.

10. The apparatus of claim 8, further comprising a processor configured to:
select at least one of the antennas based on instructions provided via the user interface; and
control at least one of the radiators to move so that each selected antenna is coupled to the microwave source, and each antenna not selected is not coupled to the microwave source.

11. The apparatus of claim 1, further comprising a processor configured to:
receive instructions to heat the object differently by different ones of the plurality of antennas; and
control movement of die plurality of radiators based on the instructions.

12. The apparatus of claim 4, wherein the excitation chamber is structured to guide microwaves from the microwave source preferentially towards the radiators.

13. A method of heating an object in a cavity by an apparatus comprising multiple radiators isolated from the cavity and a microwave source configured to feed the cavity with microwave energy via multiple antennas, each configured to be coupled to the cavity by a respective radiator of the multiple radiators; die method comprising
selecting at least one antenna; and
controlling at least one radiator to move in respect to the cavity so that each selected antenna is coupled to the microwave source, and each antenna not selected is not coupled to the microwave source.

14. The method of claim 13, wherein each of the radiators is in a respective waveguide open to the cavity, and controlling a radiator to move in respect to the cavity comprises controlling the radiator to move in the waveguide towards an opening between the cavity and the waveguide or away of the opening.

15. The method of claim 13, wherein the apparatus comprises an excitation chamber, excitable by microwaves from the microwave source, and wherein controlling the at least one radiator to move in respect to the cavity comprises controlling the radiators to move so that the selected antennas couple to the excitation chamber, and the antennas not selected are not coupled to the excitation chamber.

16. The method of claim 13, wherein controlling a radiator to move comprises controlling a motor to move the radiator.

17. The method of claim 13, further comprising:
receiving instructions to what extent to heat the object by each one of the plurality of antennas; and
controlling movement of the plurality of radiators based on the instructions.

18. The method of claim 17, wherein receiving instruction comprises receiving from a user interface configured to allow a user to provide instructions to heat the object differently by different ones of the plurality of antennas.

19. The method of claim 17, further comprising:
monitoring the amount of energy coupled to the cavity by each of the antennas; and
comparing amounts of energy coupled to amounts of energy determined to be coupled,
wherein controlling movement of the plurality of radiators comprises controlling based on the comparison.

20. An apparatus for heating an object in a cavity by microwave energy, the apparatus comprising:
multiple antennas;
a microwave source configured to feed the cavity with microwave energy via the multiple antennas;
multiple waveguides, each open to the cavity; and
multiple radiators, each in a respective one of the multiple waveguides, electrically isolated from the respective one of the multiple waveguides, and configured to controllable move so as to couple the source to a respective one of the multiple antennas or decouple the source from the respective one of the multiple antennas.

21. The apparatus of claim 20, further comprising an excitation chamber, excitable by microwaves from the microwave source, and wherein each radiator of the plurality of radiators is configured to couple the excitation chamber to the cavity through one of the plurality of antennas.

22. The apparatus of claim 20, further comprising at least one motor configured to move each of the plurality of radiators in respect to the cavity independently of the movements of the other radiators.

23. The apparatus of claim 22, wherein each of the at least one motor is electrically isolated from the radiator.

24. The apparatus of claim 20, wherein the antennas are arranged in a two dimensional array.

25. The apparatus of claim 20, further comprising a user interface configured to allow a user to provide instructions to heat the object differently by different ones of the plurality of antennas.

26. The apparatus of claim 20, further comprising a processor configured to:
select at least one of the antennas; and
control at least one of the radiators to move so that each selected antenna is coupled to the microwave source, and each antenna not selected is not coupled to the microwave source.

27. The apparatus of claim 25, further comprising a processor configured to:
select at least one of the antennas based on instructions provided via the user interface; and
control at least one of the radiators to move so that each selected antenna is coupled to the microwave source, and each antenna not selected is not coupled to the microwave source.

28. The apparatus of claim 20, further comprising a processor configured to:
receive instructions to heat the object differently by different ones of the plurality of antennas; and
control movement of the plurality of radiators based on the instructions.

29. The apparatus of claim 21, wherein the excitation chamber is structured to guide microwaves from the microwave source preferentially towards the radiators.
